(19) United States
(12) Patent Application Publication
(10) Pub. No.: US 2010/0121873 A1
(43) Pub. Date: May 13, 2010

(54) METHOD AND SYSTEM FOR DETERMINING CORRELATION BETWEEN CLINICAL EVENTS

(75) Inventors: George W. Gray, North Andover, MA (US); Mohammed Saeed, Cambridge, MA (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 12/595,258

(22) PCT Filed: Mar. 26, 2008
(86) PCT No.: PCT/IB2008/051135

§ 371 Date: Oct. 9, 2009

Related U.S. Application Data
(60) Provisional application No. 60/911,541, filed on Apr. 13, 2007.

(51) Int. Cl. G06F 17/30

(52) U.S. Cl. 707/769; 707/E17.014

(57) ABSTRACT

The present application relates to improving healthcare practices in clinical facilities. In a facility that utilizes electronic patient charts (16), a correlation processor (24) discovers correlations between events as defined by a user of the system. The user first selects an anchor event. Then the user selects a related event. Both the anchor events and the related events can be run through appropriate filters to eliminate unwanted results. The user then defines a relationship between the anchor event and the related event. The correlation processor (24) then searches through the patient charts (16) for the correlation as defined by the user. Results are displayed for the user in a format designated by the user.

The present application relates to care and treatment of patients in a clinical setting. It finds particular application in correlating events that occur in the course of a patient's care and will be described with particular reference thereto. It is to be understood that the present application can be used in any situation where events are recorded, and not necessarily only in a clinical care setting.

Data placed in a patient's chart can be viewed as a series of time based events. These events are often related to other events that are also recorded in the chart. Retrospective analysis of the information presents several difficulties. First, the data is changing over time. As a patient's care proceeds, new measurements, notes, annotations, diagnoses, instructions, and the like are being continuously added to the patient's chart. Relationships between data entries also vary, for example, on the condition of the patient, on treatments being delivered, or protocol being followed in the clinical setting, and the like. Events that may not be significant to the care of one patient may be pertinent to diagnosis or care of another patient, depending on the patient's personal circumstances.

Retrospective analysis of clinical data has been historically performed manually through the audit of paper records, namely, a paper chart in which the events throughout the patient's care are recorded. With the introduction of clinical information systems (CIS) came the ability to analyze clinical data using standard, off the shelf analysis tools. A small subset of this data can be aggregated across an entire institution and shown relative to a specific group of patients. This information includes, but is not limited to, details such as how many patients were in a clinical unit for a specified period of time, or what was the break down by age, gender, diagnosis, mortality, or other factors. This data tends to be charted once per patient chart and can be tabulated or summarized in a variety of forms. A larger set of data is recorded in a patient chart on a regular, continuing basis and are typically each associated with a point in time. This data can include measurements such as vital signs, lab results, administered medications, and the like. These elements of data are used primarily in the care of patients and are valuable data elements recorded in the chart. Added value of such data, however, can be achieved by correlating various pieces of data in the chart with the patient's response to treatments while in the institution. The sheer volume of data, as vital signs are taken often and medications or treatments are administered on a regular basis, can be overwhelming, and inhibitive to a meaningful study of the correlations between such data elements.

Previous data analysis tools have been geared toward the financial and manufacturing segments of business enterprises. These tools typically focus primarily on data that can be summarized, totaled, or counted easily. Unlike the analysis of financial data, the analysis of clinical data tends to focus more on identifying a set of physiologic conditions and determining the existence and impact of related treatments and care. This type of data varies in time and the relationship of one event with another may vary depending on the patient, their condition and the treatments being administered.

Off the shelf tools are typically unable to address this area of analysis which aims squarely at the primary objective of the clinician to improve the care and clinical outcomes of their patients. For example, it is expected that patients whose mean blood pressure drops below 65 be treated with vasopressor medications, a bolus of fluid, or other accepted method of treatment. It is also expected that this treatment would occur within a specific time window of the low blood pressure occurrence. Presently, there is no reliable method that enables clinicians to assess whether this type of treatment is being administered in a consistent manner across patients and with equal vigilance throughout the day.

The present application provides a new and improved method and apparatus of compiling and correlating significant events in a patient's care, which overcomes the above-referenced problems and others.

In accordance with one aspect, a method of correlating occurrences in patients' charts is presented. A definition of an anchor event is received that reflects an occurrence in the course of the patients' stay at a healthcare facility that is recorded in the patients' charts. A definition of at least one related event is received that occurs in charts containing the anchor event. A definition of at least one relationship of the at least one related event to the anchor event is received. The patients' charts are searched for charts containing the anchor event and the related event related as defined. A report is generated that illustrates occurrences of the anchor event with the at least one related event as defined by the at least one relationship.

In accordance with another aspect, a healthcare facility network is presented. The network includes a plurality of electronically stored patient charts, the charts containing electronically searchable data. An anchor event list contains a plurality of anchor event definitions. A related events list contains a plurality of related event definitions that can be correlated with the anchor events. A correlation processor uses the definitions of an anchor event and at least one related event and a defined relationship between the events and searches the patient charts for the correlation as defined.

In accordance with another aspect, a method of discovering event correlations is provided. One or more definitions of an anchor are selected. One or more definitions of a relationship to the anchor event are selected. Patient charts are searched for related events that fulfill the relationship to each defined anchor event. A report is generated that presents the discovered related events to a user.

One advantage lies in correlating various pieces of data in a patient's chart.

Another advantage resides in monitoring for inconsistent patient care.

Another advantage lies in correlating data in the patient's chart with the patient's response to treatments.

Another advantage lies in the ability to share correlations.

Another advantage is that it aids in the detection and avoidance of medical malpractice.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

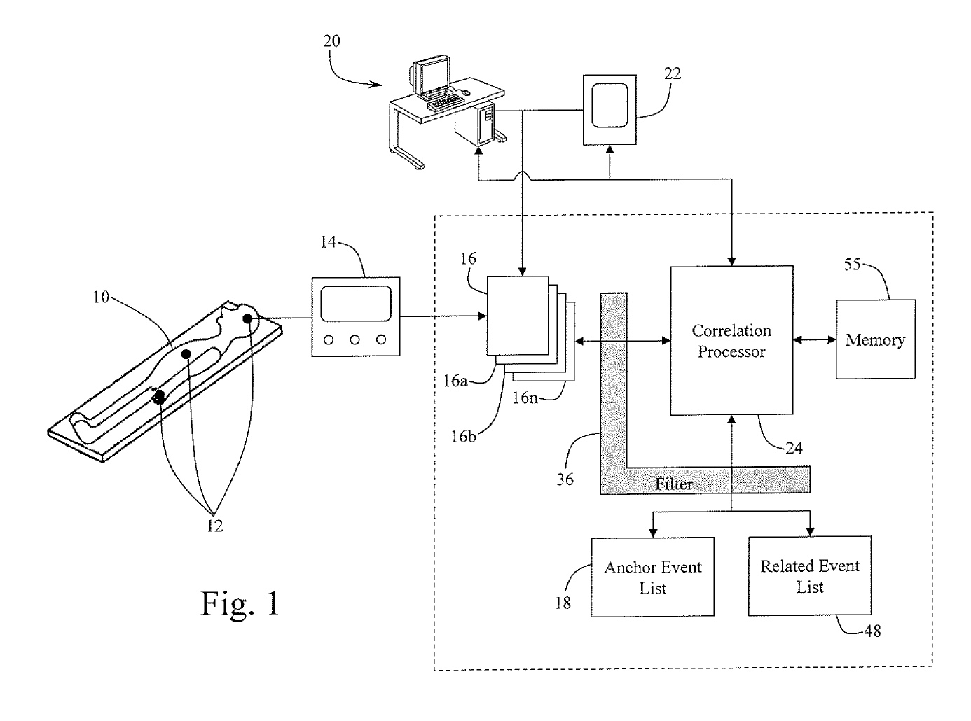

FIG. 1 is diagrammatic illustration of an event correlating system, in accordance with the present application;

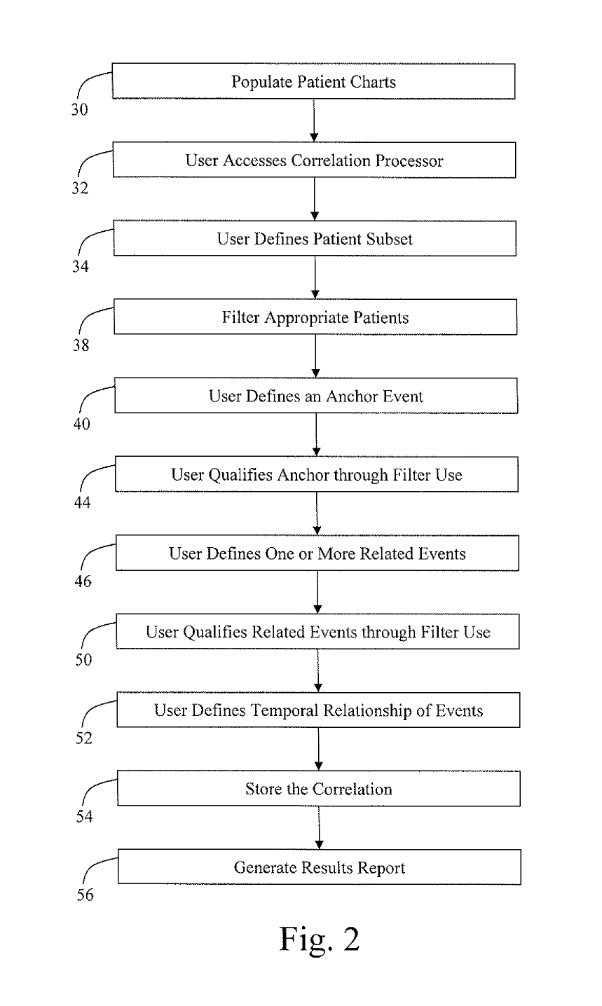

FIG. 2 is a flowchart of exemplary steps taken in a process of event correlation;

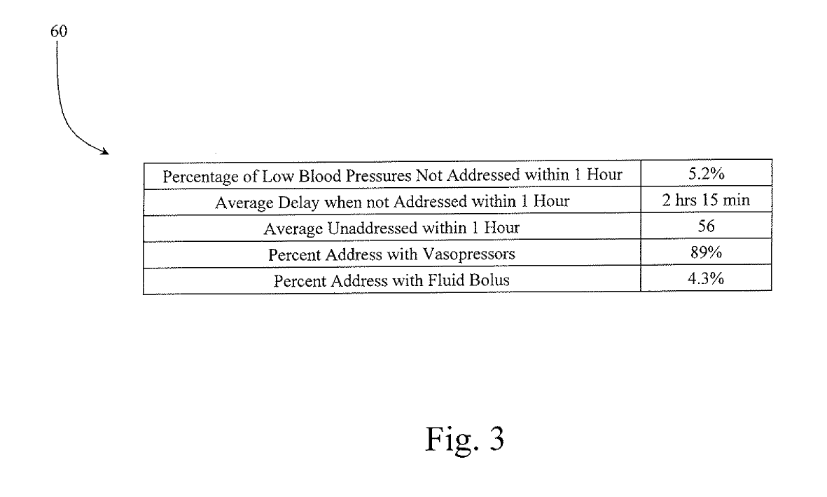

FIG. 3 is an exemplary summary report for presentation to a user;

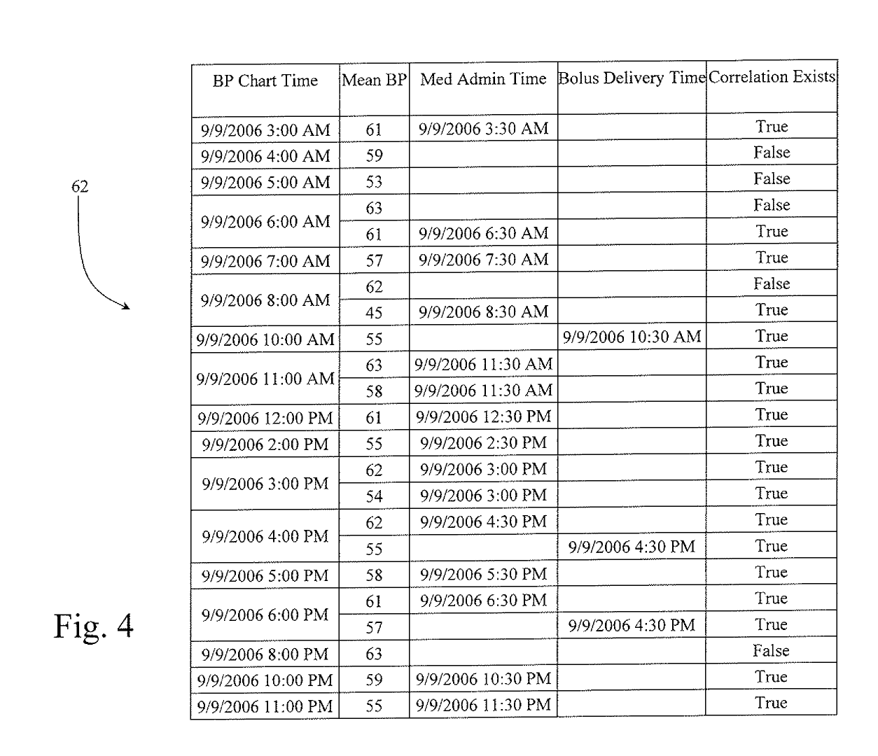

FIG. 4 is an exemplary detailed report for presentation to a user;

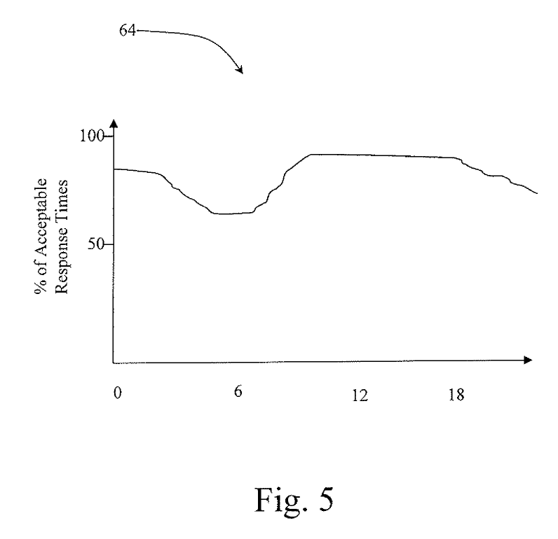

FIG. 5 is an exemplary graphical summary for presentation to a user.

With reference to FIG. 1, a patient 10 is in a clinical setting receiving long term care. Throughout the course of the patient's care, various measurements are taken regarding the patient's health. These measurements can be routine, such as blood pressure, pulse rate, body temperature, blood sugar levels, and the like, or they could be less routine, such as an ECG, a stress test, and the like. The measurements can be taken automatically, by sensors 12 located on the patient, and recorded by a patient monitor 14, or they can be taken manually by a healthcare professional, such as a nurse, doctor, orderly, or technician. The measurements can also be made as a result of laboratory tests.

As a matter of routine, these measurements are given a time stamp and recorded in the patient's chart 16. Preferably, the chart is electronic, and accessible by the healthcare professionals with the proper security clearance via a healthcare facility network 18. The healthcare facility may still use paper charts, and record measurements by hand. In this situation, a healthcare professional would later enter the data manually to the patient's electronic chart 16 via a computer 20 connected to the network (such as a nurses' station) or any other wireless portable device 22 connected to the facility network 18, such as a tablet PC, laptop, palm pilot, Blackberry, cellular phone, and the like. Additionally, the network 18 need not be restricted to a single healthcare facility; it can include multiple facilities, or even a public database (without patient identifiers, for privacy purposes).

Medical professionals will routinely enter other information in the patient's chart. These entries are essentially boundless in scope, and can encompass notes taken in a patient interview, mental state, pallor, suspected diagnoses, care instructions, medications or treatments administered, results of tests, occurrences of clinical consultations, and myriad other possibilities that can occur over the course of a patient's stay in a healthcare facility. In relatively little time, the patient's chart 16 can become quite extensive.

Also stored in the facility network 18 are the charts of other patients (16a, 16b . . . 16n). Often elements contained within the patients' charts may become of interest to a healthcare professional, for example, a shift supervisor that is interested in improving the efficiency of his or her staff. Perhaps a doctor reads an article in a medical journal and wishes to find out if his facility is practicing the techniques espoused in the article. Perhaps in-house counsel heard of another facility getting into legal trouble from certain practices. The lawyer could then check to verify that similar practices are not performed at the facility that he or she represents. At this point, it has become beneficial to correlate key events that appear in the patients' charts.

Given the extreme volume of data contained in the patients' charts, manually sifting through the information could be impracticable, and human error prone. Moreover, occurrences of single events are often uninteresting. Multiple related events are often more telling of how well the facility is operating. For instance, if a patient's mean arterial pressure (MAP) drops below 65, it is common practice to deliver a bolus of intravenous fluids, and/or treat with vasopressor medications. If a healthcare professional could correlate one event with the other, that is, how often low blood pressures are being treated within a reasonable time, such a correlation has increased value to one doing an investigation. The healthcare facility network 18 includes a correlation processor 24 that allows a healthcare professional at a user interface to express detection criteria and the relationship between one event and another event and to detect the described events within time series data. The healthcare professionals can retrospectively look across a patient population and determine when or how often two or more clinical events exist, and their time relationship.

With reference now to FIG. 2 and continuing reference to FIG. 1, a flowchart of an exemplary embodiment is provided. As mentioned previously, the patients' charts are populated 30 with measurements, annotations, instructions, diagnoses, notes, and the like, either automatically via measurement devices 12, or entered by healthcare professionals. When a healthcare professional is ready to correlate events, that is, they have an idea they would like to investigate, the user accesses the correlation processor 32. This step can be done through a graphic user interface included in the networked computer 20 or other portable device 22. Depending on the correlation that the healthcare professional wishes to make, they may want to restrict the scope of the correlation. For example, the professional may want to investigate the viability of a certain treatment of a disease, which would implicate a search through all available charts. Alternately, the professional may want to inquire as to the care provided by a specific care unit, which would initially limit the inquiry to a much smaller subset of the entire patient population. Apropos, the user can optionally initially define a subset of patients 34, although the user could search all charts in the database if he or she desires. A set of defined filters 36 are used to allow selection of certain patient parameters based on location of the patient, dates of care, demographics of the patient, category of care/admission, outcome, and the like. Any combinations of these or other filters can be used and the filter options can be joined using logical operators (e.g. AND, OR) to form intersections between the filters. An exemplary, inexhaustive list of possible filters includes clinical unit, department, admission type, dates of care, mortality, discharge location, hospital service, source of admission, age of the patient, date of birth, ethnic group, nationality, patient type, and race. Once the desired filter(s) 36 is chosen, then the filter 36 operates to eliminate patient charts not included in the user's request 38. One example could be that the user wants to filter out all patients except those who are male, admitted to the intensive care unit, and admitted within a user-defined two month period.

After desired filters are applied, the user defines an anchor event 40. The anchor event is a primary event with which other events are to be correlated. The user chooses the anchor event from a list 40 that is automatically generated. Alternately, the user can custom define an anchor event. The list includes of all data charted within the clinical information system and is made up of all data elements and their attributes. It is conceivable that the fluidity and diversity of language can impede the process at this stage. For example, if the user selected “heart attack” as the anchor event, but many other healthcare professionals called them “myocardial infarctions” or “MIs” when charting the event, the user may inadvertently miss valuable data. The Systematized Nomenclature of Medicine or “SNOMED” language system is useful in this situation because it standardizes medical jargon. The SNOMED system uses common identifiers to reduce the chances that relevant data will be missed because of disparate choices of language. Another possible employable system is the ICD9 system that standardizes billing codes. If the anchor event involves billing in some way, the ICD9 system can assist with billing jargon as the SNOMED system can assist with medical jargon.

As with the general patient selection, the user can optionally qualify an anchor event further through the use of filters 44. Any combination of these filters can be used, and like the population filters, the anchor event filters can be joined using logical operators. The available filter options can be pre-defined and based on the properties of the selected data. An exemplary inexhaustive list of properties includes numeric, string, and date value, unit of measure, associated material, associated site, current site, stored time, and charted time. An exemplary inexhaustive list of filters includes operators such as exists, is equal to, is less than, is less than or equal to, is greater than, is greater than or equal to, is increasing by at least ‘x’ over time window ‘y’, is decreasing by at least ‘x’ over time window ‘y’, is like, is minimum value, is maximum value, is first charted event, and is last charted event. Returning to the blood pressure example, the selected anchor could include MAPs under 65 that have been decreasing over a two hour period by at least 5 mmHg. Additionally, the user can select to have specific property values returned with the data.

Next, the user defines one or more related events to be correlated with the anchor event 46. Like the anchor events, the related events can be stored in a related events database 48 in the standardized SNOMED terminology. Also similar to the anchor events, the user can qualify the related events through the use of filters 50 to further limit what data will be returned. Next, the user may also define the relationship that each related event has to the selected anchor event 52. The user can define this relationship in terms of time (e.g., within ‘x’ minutes of the anchor event) or through one or more relationships between the anchor event's properties and the related event's properties.

Upon completion of the definition of the correlation, the user can store the correlation 54 in a correlation memory 55. Assumedly, the user will want to run the correlation immediately, but it is not necessary. Additionally, the correlation can be both run and stored, with the idea in mind to run the correlation again at a later date, or periodically. For example, if a shift supervisor runs a correlation now and discovers a deficiency, he or she can take action in an attempt to cure that deficiency. Several weeks later, the supervisor can run the correlation again to assess whether the action has had the desired effect on the events in question.

When the user runs the correlation, a report is generated 56. The user can view the results on screen, print the results, configure the correlation to store its results in the clinical information system's database, schedule ongoing analysis of patient charts using this correlation, or publish the correlation so that other users can use it as well. FIG. 3 depicts an exemplary summary report 60 that can be produced by the correlation processor. In the summary report, the overall findings of the correlation are presented. Optionally, as shown in FIG. 4, the user can generate a more detailed summary 62 which can show the individual results that were compiled into the summary report 60. Additionally, the user may choose to plot a graphical representation of their data. With reference to FIG. 5, the user produces a graph 64 that compares vigilance with time of day. The x-axis shows the time of day, while the y-axis shows the percentage of events that require the attention of a healthcare professional that were attended to in the prescribed time.

It is to be understood that the user can create their own anchor events or related events, and are not limited to the SNOMED language or by the events included in the anchor event list 42 or the related events list 48. Medicine is continually advancing, and as new diagnoses and new methods of treatment arise, users will not be bound by old definitions or old treatments or have to wait for a software upgrade that incorporates the new data. If a descriptor is not yet available, the user can create one that suits his/her needs in the given situation.

Further, known valuable correlations can be included and stored in the memory 55 for use without the need to be created. These correlations are tested, and are known to produce satisfactory results. For these correlations, at least, the user will not need to worry about whether they have adequately described the correlation (e.g., did the request filter out too many cases, was the request overly broad, etc.) Some exemplary correlations are included:

### Medication Correlations

Administration of vasopressors versus the patient's MAP
Administration of insulin versus the patient's serum glucose level
Administration of propofol versus the patient's Glascow coma score
Administration of morphine or Fentanyl versus the patient's pain scale
Administration of diuretics versus the patient's pulmonary arterial pressure (PAP), pulse oximetry data (SpO₂) and urine output
Administration of nitroprusside versus the patient's MAP and intracranial pressure (ICP)

### Fluid Correlations

Delivery of IV fluid bolus versus the patient's central venous pressure (CVP), PAP, and MAP
Delivery of packed red blood cells versus the patient's hematocrit (HCT), oxygen saturation (O₂Sat), and partial pressure of arterial oxygen (PAO₂)
Delivery of platelets versus the patient's platelet count
Delivery of total parenteral nutrition (TPN) versus the patient's blood glucose
Delivery of colloids versus the patient's serum albumin

### Diagnostic Correlations

A diagnosis of severe sepsis versus the patient's prior white blood cell count (WBC), temperature and blood pressure as well as a patient's length of stay and mortality
A diagnosis of acute respiratory distress syndrome versus the patient's prior tital volume, peep, and WBC
A diagnosis of hypovolemia versus the total fluid intake of the patient
A diagnosis of renal failure versus the patient's prior creatinine and blood urea nitrogen levels

In an alternate embodiment, the user does not have to select a related event with which to correlate the anchor event. This embodiment is beneficial from a research standpoint, and the correlation processor 24 is used to do data mining, defining correlations rather than searching for user-selected correlations. The healthcare professional would use this embodiment when they have an anchor event that they wish to learn more about. In an illustrative example, a healthcare professional recognizes an abnormally high rate of post-operation infection. In an effort to determine a cause of the infections, the professional searches for any event that occurred the day before onset of the infection in at least 90% of the patients presenting with the infection. Many of the returned correlations may be dismissed as incidental, but the professional may stumble upon a common event that would explain the infection occurrences.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A healthcare facility network comprising:
a plurality of electronically stored patient charts, the charts containing electronically searchable data;
an anchor event list that contains a plurality of anchor event definitions;
a related events list that contains a plurality of related event definitions that can be correlated with the anchor events;
a correlation processor that uses the definitions of an anchor event and at least one related event and a defined relationship between the events and searches the patient charts for the correlation as defined.

2. The healthcare facility network as set forth in claim 1, further including:
filters that function to preemptively filter out undesired results as defined by a user.

3. The healthcare facility network as set forth in claim 1, further including a correlation memory where previously defined correlations are stored for later use or dissemination.

4. The healthcare facility network as set forth in claim 1, wherein the event lists are normalized by the SNOMED descriptors of medical parlance.

5. The healthcare facility network as set forth in claim 1, further including a user interface on which the relationship between the events is entered using at least one Boolean operator.

6. The healthcare facility network as set forth in claim 1, wherein the correlation processor generates a report that presents the correlation to a user.

7. A method of correlating occurrences in patients' charts comprising:
receiving a definition of an anchor event that reflects an occurrence in the course of the patients' stay at a healthcare facility that is recorded in the patients' charts;
receiving a definition of at least one related event that occurs in charts containing the anchor event;
receiving a definition of at least one relationship of the at least one related event to the anchor event;
searching the patients' charts for charts containing the anchor event and the related event related as defined; and
generating a report that illustrates occurrences of the anchor event with the at least one related event as defined by the at least one relationship.

8. The method as set forth in claim 7, further including:
receiving a definition of a filter;
filtering out a subset of the patients' charts that are not to be searched as described by the definition of the filter.

9. The method as set forth in claim 7, further including:
storing the definitions of the events and relationship for later correlation.

10. The method as set forth in claim 9, further including:
disseminating the stored definitions and relationship to healthcare professionals for their use.

11. The method as set forth in claim 7 wherein the step of receiving an anchor event includes:
a user choosing the anchor event from a list of anchor events.

12. The method as set forth in claim 7, wherein the received definitions are systematically generated electronically to mine for relationships.

13. The method as set forth in claim 11, wherein the list of anchor events is normalized by the SNOMED descriptors of medical parlance.

14. The method as set forth in claim 7, wherein the at least one relationship is described by at least one Boolean operator.

15. The method as set forth in claim 7, wherein the step of generating a report includes generating a report that summarizes the findings of the correlation.

16. The method as set forth in claim 7, wherein the step of generating a report includes generating a detailed list of the findings of the correlation.

17. The method as set forth in claim 7, wherein the step of generating a report includes generating a graphical representation of the findings of the correlation.

18. The method as set forth in claim 7, wherein the report generating step generates at least one of:
a summary report;
a detailed report;
a graphical report;
an on-screen report;
a printed report;
a report stored in a system database;
a publication of the correlation; and,
a recurring correlation incidence.

19. A computer data storage medium or computer program that performs the method as set forth in claim 7.

20. A report generated by the method of claim 1.

21. A method of discovering event correlations comprising:
selecting one or more definitions of an anchor;
selecting one or more definitions of a relationship to the anchor event;
searching patient charts for related events that fulfill the relationship to each defined anchor event;
generating a report that presents the discovered related events to a user.

22. The method as set forth in claim 21, wherein the generated report includes a percentage of occurrence in charts containing the anchor event and the selected relationship.
